(19) United States
(12) Patent Application Publication
(10) Pub. No.: US 2008/0197970 A1
(43) Pub. Date: Aug. 21, 2008

(54) REMOTE ACCESS SYSTEM

(75) Inventor: Mark Fouts, Farmington Hills, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 11/675,262

(22) Filed: Feb. 15, 2007

(51) Int. Cl. G05B 19/00

(52) U.S. Cl. 340/5.64; 340/5.72

(57) ABSTRACT

The embodiments described herein include a remote access system that transmits access signals for access to objects (e.g., vehicles, buildings and the like). The remote access system includes a circuitry package being integrated with a telecommunications device. Upon the receipt of an input, telecommunications device is configured to transmit the access signals.

### TECHNICAL FIELD

The embodiments described herein relate to a remote access system.

### BACKGROUND

Keyless entry systems are commonly used to enable a vehicle operator to remotely access a vehicle. These systems typically include a key fob having a plurality of buttons that unlock or lock doors on the vehicle. Conventional key fobs typically include a discrete electronic module or an electronic module that is integrated with a vehicle key. Although the conventional key fobs are useful, they are typically bulky and in some instances inconvenient for users.

The embodiments described herein were conceived in view of these and other disadvantages of conventional keyless entry systems.

### SUMMARY

The embodiments described herein include a remote access system. The remote access system includes a circuitry package configured to transmit an access signal. An energy source is included that is coupled to the circuitry package for energizing the circuitry package. A telecommunications device having a housing contains the circuitry package and the energy source. The telecommunications device is configured to transmit the access signal in response to the input.

### BRIEF DESCRIPTION OF THE DRAWINGS

The novel features of the described embodiments are set forth with particularity in the appended claims. These embodiments, both as to their organization and manner of operation, together with further advantages thereof, may be best understood with reference to the following description, taken in connection with the accompanying drawings in which:

FIGS. 1A and 1B illustrate a remote access system in accordance with an embodiment of the present invention; and

FIG. 2 illustrates a block diagram of the remote access system of FIGS. 1A and 1B.

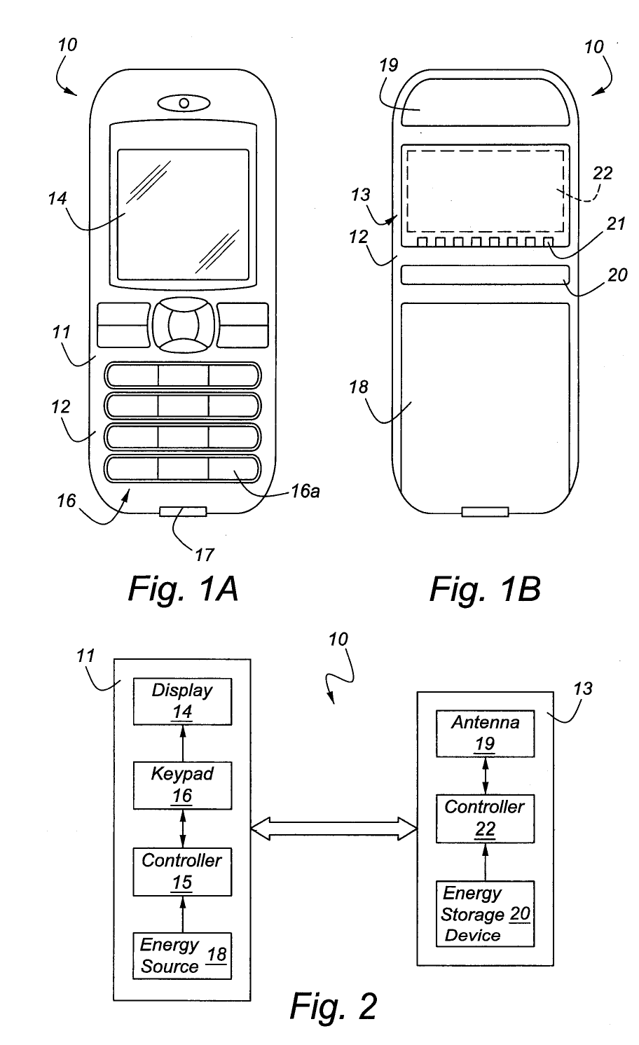

### DETAILED DESCRIPTION OF THE PREFERRED EMBODIMENT(S)

As required, detailed descriptions of embodiments are disclosed herein. However, it is to be understood that the disclosed embodiments are merely exemplary of the invention that may be embodied in various and alternative forms. The figures are not necessarily to scale, and some features may be exaggerated or minimized to show details of particular components. Therefore, specific functional details disclosed herein are not to be interpreted as limiting, but merely as a representative basis for the claims and/or as a representative basis for teaching one skilled in the art.

Referring to the Figures, the embodiments described herein include a remote access system 10 that is configured to transmit a wireless signal to an object (e.g., a vehicle, a building and the like) to perform a function (e.g., gain entry, start an engine, turn on lights, heat, etc.). In one embodiment, remote access system 10 may be a keyless entry system that enables a user to access a vehicle. In some embodiments, the access signal may be a keyless entry signal or an ignition signal. As such, remote access system 10 may be used to lock and unlock doors, start a vehicle engine, and the like. Remote access system 10 includes a telecommunications device 11 having a circuitry package 13 that enables the wireless transmission of access signals to objects for access. In the embodiments described herein, the remote access system 10 will be described in the context of a keyless entry system, but is equally applicable to other systems without departing from the scope of the present invention.

Telecommunications device 11 may be a mobile device such as a cellular telephone, a personal digital assistant (PDA), and the like. As such, telecommunications device 11 may be configured to transmit individually or any combination of voice signals, data signals, and video signals. Telecommunications device 11 includes at least one port 17 and a housing 12. Port 17 enables remote access system 10 to be electrically connected to other devices for charging programming, data transmission, etc. Housing 12 contains and/or encloses the various components of remote access system 10 including circuitry package 13.

As shown, telecommunications device 11 also includes a display 14 and a keypad 16 having a plurality of buttons or keys 16a. Telecommunications device 11 may receive inputs via buttons 16a. For example, the user may select a series of buttons 16a, thereby causing the transmission of the access signal. In some embodiments, a specific button 16a may be programmed to cause the transmission of the access signal when selected.

Accordingly, remote access system 10 includes a controller 22 that is operable with keypad 16. Controller 22 is adapted to generate specific digital codes that correspond with a vehicle receiver (not shown) to cause locking and unlocking of vehicle doors, starting of a vehicle engine and/or activation of virtually any other vehicle functions. As shown in FIG. 2, telecommunications device 11 may include a dedicated controller 15 that processes information and generates data and signals for conventional mobile device functions including, but not limited to, telephone functions. An energy source 18, which may be a battery, a capacitor, and the like, serves as a primary energizing source for telecommunications device 11 including the circuitry package 13. Energy source 18 may be rechargeable energy source.

Circuitry package 13 includes, in one embodiment, an energy storage device 20, a controller 22, and an antenna 19. Circuitry package 13 may be embodied as a discrete electronic module or a plurality of electronic components. In one aspect of the invention, circuitry package 13 may be a transceiver that is configured to transmit and receive access signals (e.g., keyless entry signals and/or ignition signals).

As shown, controller 22 may be electrically coupled to remote access system 10 via contacts 21 so as to enable the transmission and reception of electrical signals. Controller 22 has a memory that contains a plurality of digital codes that are compatible with codes stored by a receiving device (not shown). The digital codes may be stored within controller 22 in a manner known to those of ordinary skill in the art. Upon entry of a predetermined input via keypad 16, controller 22 processes, sends and receives digital codes via antenna 19.

Energy storage device 20 may be a rechargeable energy source and serve as a secondary energy source for circuitry package 13. Unlike conventional key fobs that require physical replacement of an internal battery over time, remote access system 10 may be recharged to maintain its operability. The energy storage device 20 may be recharged by connecting remote access system 10 to a vehicle power point or an electrical receptacle. Also, in the event that energy source 18 (FIG. 2) is insufficiently charged (i.e., below a predetermined voltage level of 2-3 volts) or simply unable to power circuitry package 13, energy storage device 20 provides power to circuitry package 13. Controller 22 is configured to access the ability of energy source 18 to power remote access system 10 and control the use of energy from energy source 18 and energy storage device 20. As such, even if telecommunications device 11 is unable to carry out its standard functions (e.g., phone functions, calendar functions, email functions, etc.) due to insufficient battery power, remote access system 10 remains able to generate the access signals for access to vehicles, buildings, and the like.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A remote access system comprising:
a circuitry package configured to transmit an access signal;
an energy source coupled to the circuitry package for energizing the circuitry package; and
a telecommunications device having a housing containing the circuitry package and the energy source, the telecommunications device causing the transmission of the access signal in response to an input.

2. The system of claim 1, wherein the access signal includes a keyless entry signal.

3. The system of claim 2, wherein the telecommunications device includes a mobile device configured to transmit at least one of voice, data, and video signals.

4. The system of claim 3, wherein the telecommunications device includes a keypad having at least one button, wherein the input is received via the button located on the keypad.

5. The system of claim 4, wherein the circuitry package includes a transceiver configured to transmit the keyless entry signal and receive the keyless entry signal.

6. The system of claim 5, wherein the transmitted keyless entry signal is received by at least a receiver device, the receiver device then generating a door signal for locking or unlocking a door.

7. The system of claim 1, wherein the circuitry package includes:
a controller for processing the input and generating the access signal; and
an antenna for wirelessly transmitting the access signal.

8. The system of claim 7, wherein the access signal includes a data signal having a digital code for locking or unlocking a door.

9. The system of claim 1, wherein the access signal includes an ignition signal.

10. A remote access system for wirelessly transmitting an access signal, the system comprising:
a circuitry package configured to transmit an access signal, the circuitry package having:
a secondary energy storage device for storing energy and powering the circuitry package,
a controller for generating the access signal, and
an antenna for wirelessly transmitting the access signal; and
a telecommunications device having:
a primary energy storage device for powering the remote access system, and
a housing containing the circuitry package and the primary energy storage device, the telecommunications device causing the transmission of the access signal in response to an input.

11. The system of claim 10, wherein the access signal includes a keyless entry signal.

12. The system of claim 11, wherein the telecommunications device includes a mobile device configured to transmit at least one of voice, data, and video signals.

13. The system of claim 12, wherein the telecommunications device includes a keypad having at least one button, wherein the input is received via the button located on the keypad.

14. The system of claim 13, wherein the circuitry package includes a transceiver configured to transmit the keyless entry signal and receive the keyless entry signal.

15. The system of claim 14, wherein the transmitted keyless entry signal is received by at least a receiver device, the receiver device then generating a door signal for locking or unlocking a door.

16. The system of claim 10, wherein the access signal includes a data signal having a digital code for locking or unlocking a door.

17. The system of claim 10, wherein the access signal includes an ignition signal.

18. A keyless entry system for a vehicle having at least one door, the system comprising:
a telecommunications device for transmitting at least one of voice, data, and video signals, the telecommunications device having:
a keypad for receiving an input,
a display for displaying information corresponding to the input,
a power source that powers the telecommunications device, and
a housing containing the keypad, the display and the power source; and
a circuitry package integrated with the housing and configured to transmit a digital code to the vehicle, the circuitry package having:
a controller having the digital code stored within a memory, the controller processing the input and outputting the digital code, and
an antenna coupled to the controller for wirelessly transmitting the digital code to the vehicle to enable locking or unlocking of the at least one door.

19. The system of claim 18, wherein the telecommunications device includes at least one of a mobile telephone and a personal digital assistant.

20. The system of claim 18, further comprising a secondary energy storage device coupled to the controller and adapted to power the circuitry package when the battery level is at or below a predetermined level.
